(19) United States
(12) Patent Application Publication
(10) Pub. No.: US 2009/0312886 A1
(43) Pub. Date: Dec. 17, 2009

(54) Temperature controller system

(75) Inventors: Yuichi Kikuchi, Tokyo (JP); Shuichi Mano, Tokyo (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 12/456,480

(22) Filed: Jun. 17, 2009

(30) Foreign Application Priority Data
Jun. 17, 2008 (JP) 2008-157650
Jun. 17, 2008 (JP) 2008-157651

(51) Int. Cl. G05D 23/00

(52) U.S. Cl. 700/299

(57) ABSTRACT

In a temperature controller system, a plurality of temperature controllers that adjust a temperature of a control object are to be connected to a programmable logic controller. One of the temperature controllers includes a PLC communicating portion which exchanges data with the programmable logic controller through a dedicated cable, a serial communication portion which exchanges data with the temperature controllers that are connected in a downstream side, through serial communication cable, and a communication and conversion CPU which controls the data exchange performed between the PLC communicating portion and the programmable logic controller, and which controls a serial communication performed by the serial communication portion.

### TECHNICAL FIELD

The present disclosure relates to a temperature controller system including a plurality of temperature controllers which are to be connected to a PLC (Programmable Logic Controller).

### RELATED ART

Recently, the PLC communication has been widely used. The PLC communication means communication such as CC-link, PROFIBUS, or DeviceNet in which the specification is made public. A request for enabling a temperature controller to be connected to such a PLC is increasing day by day.

In order to connect a temperature controller to a PLC, however, a dedicated component is usually required, and hence this causes the production cost of the temperature controller itself to be increased. Furthermore, the method of setting the memory map of a memory which is used in communication using a temperature controller is complicated. Therefore, it is requested to provide a temperature controller which can be easily used by the user. The following is known as a literature of the related art of connecting such a temperature controller through a network.

[Patent Reference 1] JP-A-2003-140739

Hereinafter, a related-art temperature controller system will be described with reference to FIG. 8. Referring to the figure, a configurator is installed in a personal computer (hereinafter, abbreviated to “PC”) 10. A configurator is software for registering slave apparatuses (in this example, temperature controllers 30, 40, 50) which are low-level devices in the PLC communication, into a PLC 20 which functions as a master of the PLC communication. The PLC 20 is connected to the PC 10 through a communication line L1 by means of the PLC communication or dedicated communication.

The temperature controllers 30, 40, 50 are in a slave relationship to the PLC 20 which is the master, and connected to the PLC 20 through a dedicated cable L2 by means of the PLC communication. The temperature controllers 30, 40, 50 incorporate electric data sheets (hereinafter, referred to as “EDS files”) 31, 41, 51, respectively.

For example, the EDS file 31 is an electronic file in which information of a slave apparatus (the temperature controller 30) is stored. As in the table which is shown in FIG. 9, and in which “Standard of PLC communication” and “Name of Electric Data Sheet” are contrasted with each other, such an electronic file is called “GSD file” in “PROFIBUS”, “CSP file” in “CC-link”, and “EDS file” in “DeviceNet”.

Specifically, an electronic file (in this case, “EDS file”) in which information of slave apparatuses (the temperature controllers 30, 40, 50) is stored contains:
(1) the size of a memory space installed in the master (PLC 20) occupied by the slave apparatuses (essential information);
(2) parameter information such as the names of the slave apparatuses arranged in the memory space occupied by the slave apparatuses (optional information);
(3) communication rates supported by the slave apparatuses; etc.
   The optional information is used for enhancing the convenience of the user.

The EDS file 31 and the like are made public by the manufacturer of the slave apparatus (the temperature controller 30) in the format which is defined in the standard of the PLC communication. Alternatively, they may be attached to the slave apparatus to be used, or made public on the Internet to be used.

In addition, there is a case where software for producing the EDS file 31 is provided to the user by the manufacturer of the slave apparatus (the temperature controller 30), and the user who is provided with the software uses it by a method in which the EDS file 31 is produced in accordance with the request of the user oneself.

The thus produced EDS file 31 is once stored on a recording medium such as a CD-R, and then subjected by the user to be read into the PC 10. Thereafter, the EDS file 31 is registered by the user into the PLC 20 which is the master, through the communication line L1, and the arrangement of the memory map for performing the PLC communication with the slave apparatuses (the temperature controllers 30, 40, 50) is set in the PLC 20.

With respect to the temperature controllers 40, 50 connected to the system, similarly, the EDS files 41, 51 are produced, and registered into the PLC 20 which is the master, and the memory map in the PLC 20 is set for communication.

As described above, in the case where plural temperature controllers 30, 40, 50 exist as shown in FIG. 8, the EDS files 31, 41, 51 are produced respectively for the temperature controllers 30, 40, 50, stored on a recording medium, read into the PC 10, and then set from the PC 10 into the PLC 20 through the communication line L1.

In the case where the plural temperature controllers 30, 40, 50 are connected to the one PLC 20 by means of the PLC communication, however, the user must perform the procedures of: respectively producing the EDS files 31, 41, 51 for the plural temperature controllers 30, 40, 50 while considering the parameters which are to be handled in the PLC communication; storing the EDS files 31, 41, 51 on a recording medium to be read into the PC 10; and registering the parameters of the temperature controllers 30, 40, 50 into the PLC 20 by using a configurator.

Therefore, the user must be familiar with the above-described parameters of temperature controllers, and further there is a problem in that, in the case where a plurality of temperature controllers are used, the work of registering the EDS file is performed for each of the temperature controllers, and hence very cumbersome.

Next, the configuration of the temperature controller 30 will be described with reference to FIG. 10. In order to perform the PLC communication between the PLC 20 and the temperature controller 30 and the like, the dedicated cable L2 is required for the connections therebetween. The temperature controller 30 is configured by a dedicated connector 32 to which the dedicated cable L2 is to be connected; a PLC communication circuit 33 which enables the temperature controller to perform the PLC communication; and a temperature controller circuit 34 having a function of a usual temperature controller.

In the case where the related-art temperature controller 30 is to be connected to the PLC 20, therefore, components dedicated to the temperature controller, i.e., components such as the dedicated connector 32 and the PLC communication circuit 33 are necessary.

In the case where the plural temperature controllers 30, 40, 50 are to be connected to one PLC 20 through the dedicated cable L2, however, the user must register the parameters of the respective temperature controllers 30, 40, 50 into the PLC 20 by using the configurator of the PC, for each of the temperature controllers 30, 40, 50.

Therefore, the registering work must be performed a number of times which is equal to that of the temperature controllers, and hence is cumbersome. The dedicated components are required for each of the temperature controllers, and therefore there arises a problem in that the production cost is increased.

### SUMMARY

Exemplary embodiments of the present invention provide a temperature controller system in which the setting work is simplified in a temperature controller system in the case where a plurality of temperature controllers are efficiently connected to a PLC.

Further, exemplary embodiments of the present invention provide a temperature controller system in which, when a plurality of temperature controllers are to be connected to a PLC, the connections can be realized by an economical configuration.

The exemplary embodiments of the present invention are configured in the following manners.
(1) A temperature controller system comprising:

a plurality of temperature controllers that adjust a temperature of a control object; and

a programmable logic controller to which the plurality of temperature controllers are connected,

wherein one of the temperature controllers includes
a PLC communicating portion which exchanges data with the programmable logic controller by a PLC communication,
a serial communication portion which exchanges data with another one of the temperature controllers that is connected in a downstream side, by a serial communication, and
a communication and conversion CPU which controls the data exchange performed between the PLC communicating portion and the programmable logic controller, and which controls serial communication performed by the serial communication portion.
(2) In a temperature controller system of (1), the one of temperature controllers is connected to the another one of temperature controllers that is in the downstream side, through a serial communication cable, and

wherein the serial communication portion includes
a communication control element which is a master of the serial communication performed with respect to the another one of temperature controllers that is connected in the downstream side, and
   an RS-485 circuit which exchanges data with the another one of temperature controllers that is connected in the downstream side, through the serial communication cable.
(3) In a temperature controller system of (1), the one of temperature controllers is connected to the programmable logic controller through a dedicated cable, and

wherein the PLC communicating portion includes
a PLC communication terminal to which the dedicated cable is connected, and
   a PLC communication circuit which exchanges data with the programmable logic controller through the PLC communication terminal.
(4) In a temperature controller system of (2), the another one of temperature controllers that is connected in the downstream side includes an RS-485 circuit which is connected to the serial communication cable.

The invention achieves the following effects. The plural temperature controllers can be handled as one controller, and hence the burden of the configuration work can be reduced. The dedicated cable is connected to only one of the temperature controllers, and the other connections are realized by using an economical RS-485 line. Therefore, the production cost can be reduced.

Furthermore, the exemplary embodiments of the present invention are configured in the following manners.
(5) A temperature controller system comprising:

a plurality of temperature controllers; and

a programmable logic controller to which the plurality of temperature controllers are connected,

wherein one of the temperature controllers which is used as a master includes
a file producing portion which, based on a standard set list that is obtained by means of communication from another one of the temperature controllers which is used as a slave, produces an electronic file storing information of the slave temperature controller, and
   a file recording portion which records the electronic file.
(6) In a temperature controller system of (5), the master temperature controller and the slave temperature controller communicate with each other by means of serial multidrop communication.
(7) In a temperature controller system of (6), the serial multidrop communication is RS-485 communication.
(8) In a temperature controller system of (5), the programmable logic controller and the master temperature controller are connected to each other by means of PLC communication, and the electronic file is an EDS file.
(5) In a temperature controller system of any one of (5) to (8), the electronic file is transmitted to a personal computer by means of LL communication.

The invention achieves the following effects. An EDS file is produced on the basis of the standard set lists read out from the respective temperature controllers. Therefore, the plural temperature controllers can be handled as one controller, and hence the burden of the configuration work can be reduced.

Even when the user is not familiar with parameters of the temperature controllers, the master temperature controller reads out a recommended data group of the slave temperature controllers. Therefore, one EDS file can be sufficiently used, and the handling is facilitated.

### BRIEF DESCRIPTION OF THE DRAWINGS

FIG. 1 is a diagram showing a manner of using a temperature controller system of a first embodiment of the invention;

FIG. 2 is a diagram of the temperature controller system of the first embodiment of the invention;

FIG. 3 is a view showing a data flow in the temperature controller system of the first embodiment of the invention;

FIG. 4 is a diagram showing a manner of using a temperature controller system of a second embodiment of the invention;

FIG. 5 is a diagram of the temperature controller system of the second embodiment of the invention;

FIG. 6 is view showing an example of contents of an EDS file;

FIG. 7 is a view showing a data flow in the temperature controller system of the second embodiment of the invention;

FIG. 8 is a diagram showing a manner of using temperature controllers in the related art;

FIG. 9 is a view showing a correspondence table of the standard of the PLC communication and electric data sheets; and

FIG. 10 is a diagram of a temperature controller of the related art.

### DETAILED DESCRIPTION

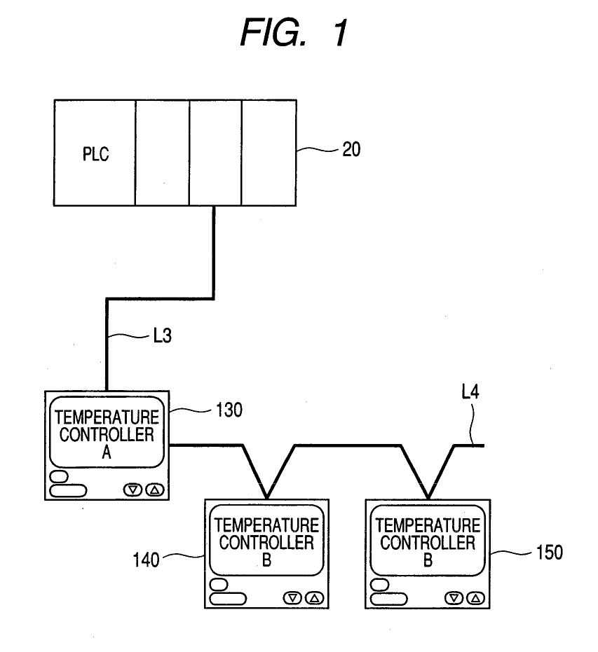

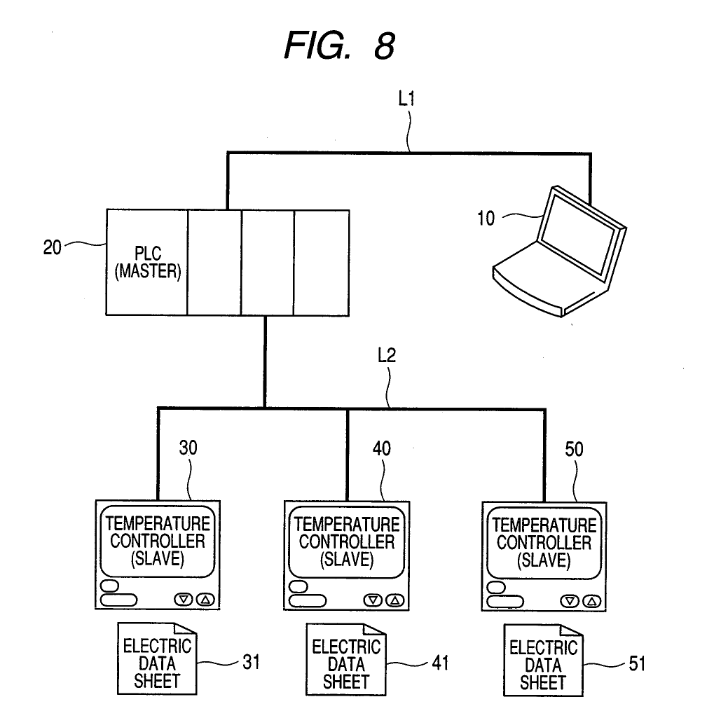

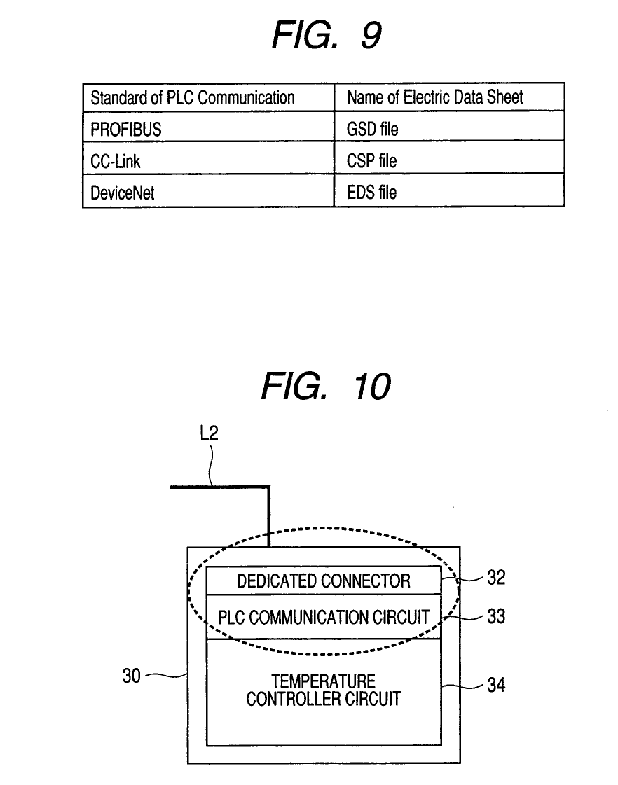

Hereinafter, a manner of using a temperature controller system of a first embodiment of the invention will be described with reference to FIG. 1. A PLC 20 is configured in a similar manner as the PLC 20 of FIG. 8, and hence its description is omitted. A temperature controller A 130 has the PLC communicating function and a communication protocol converting function. The temperature controller A 130 is a master of the RS-485 communication (serial communication), and exchanges data with temperature controllers B 140, 150, . . . which are slaves.

The temperature controllers B 140, 150 have the RS-485 communicating function, and include a list of data groups which are handled in the PLC communication. The contents of the list are determined on the basis of the type of the temperature controllers B 140, 150 and the method of using them. The list contains also parameters which are frequently read and written during operation, such as a measure value (PV), and a set value (SP).

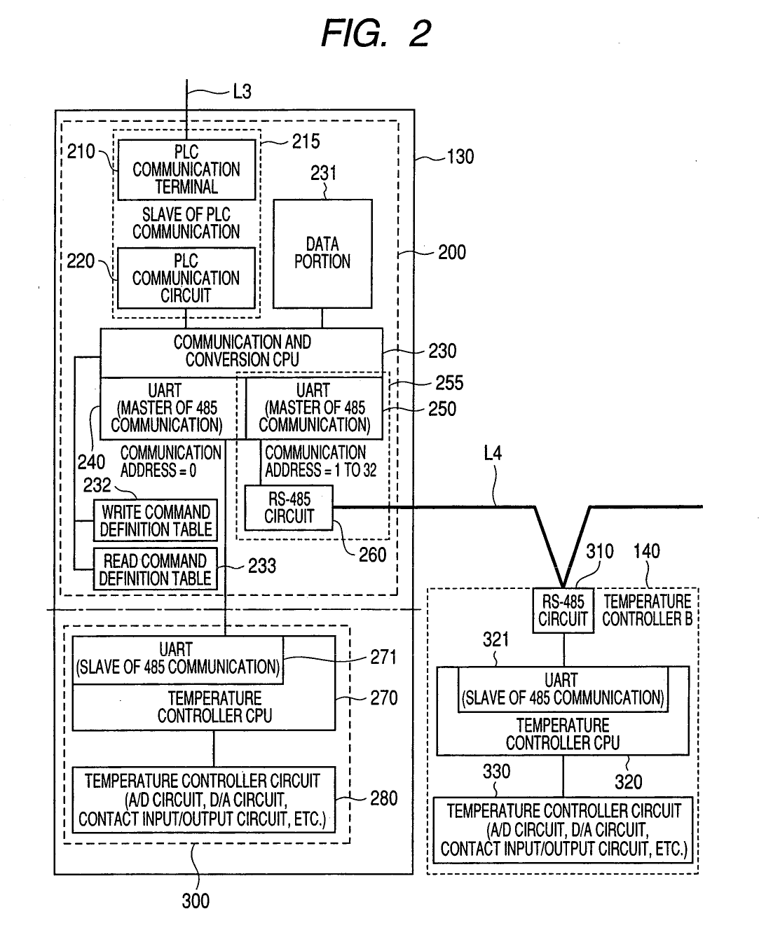

Next, the configuration and operation of the temperature controller A 130 will be described in detail with reference to FIG. 2.

FIG. 2 is a diagram of the temperature controller A 130 which is used in the temperature controller system of the invention. The temperature controller A 130 can be roughly divided into: an option board 200 having the PLC communicating function, and a function of collecting information of a temperature controller B group (which is connected to the downstream side of the communication of the temperature controller A 130); and a temperature controller block 300 having a function of a usual temperature controller.

First, the configuration of the option board 200 will be described. A PLC communication terminal 210 is connected to a dedicated cable L3. A PLC communication circuit 220 communicates with the PLC 20 on the high-level side through the PLC communication terminal 210. The PLC communication terminal 210 and the PLC communication circuit 220 constitute a PLC communicating portion 215 which functions as a slave of the PLC communication with respect to the PLC 20.

A communication and conversion CPU 230 controls the PLC communication circuit 220 to perform the PLC communication with the PLC 20 on the high-level side. A data portion 231 is a block into which data are written from the PLC 20 through the PLC communicating portion 215.

A UART (Universal Asynchronous Receiver-Transmitter) 240 is a communication control element which is a master of the RS-485 communication. For example, the communication address is set to “0”.

A UART 250 is a master of the RS-485 communication with respect to the temperature controller B group. For example, communication addresses of “1” to “32” are used.

The UART 250 converts data of peripheral devices (in this case, the temperature controller B group) to those in a format which can be handled by another apparatus (the PLC 20). An RS-485 circuit 260 is a circuit which communicates with the temperature controller B group through an RS-485 cable L4. The UART 250 and the RS-485 circuit 260 constitute a serial (RS-485) communicating portion 255.

The function of the temperature controller A 130 will be described. A temperature controller CPU 270 disposed in the temperature controller block 300 controls a temperature controller circuit 280, and also controls the RS-485 communication through a UART 271. The UART 271 is a slave of the RS-485 communication, and operates under the control of the temperature controller CPU 270. The temperature controller circuit 280 has a function of a usual temperature controller, and is configured, for example, by an A/D converter circuit, a D/A converter circuit, a contact input/output circuit, etc.

Next, the configuration of the temperature controller B 140 will be described. An RS-485 circuit 310 performs the RS-485 communication with respect to the RS-485 circuit 260 through the RS-485 cable L4. A temperature controller CPU 320 controls a temperature controller circuit 330, and also controls the RS-485 communication through a UART 321.

The UART 321 is a slave of the RS-485 communication, and operates under the control of the temperature controller CPU 320. The temperature controller circuit 330 has a function of a usual temperature controller, and is configured, for example, by an A/D converter circuit, a D/A converter circuit, a contact input/output circuit, etc.

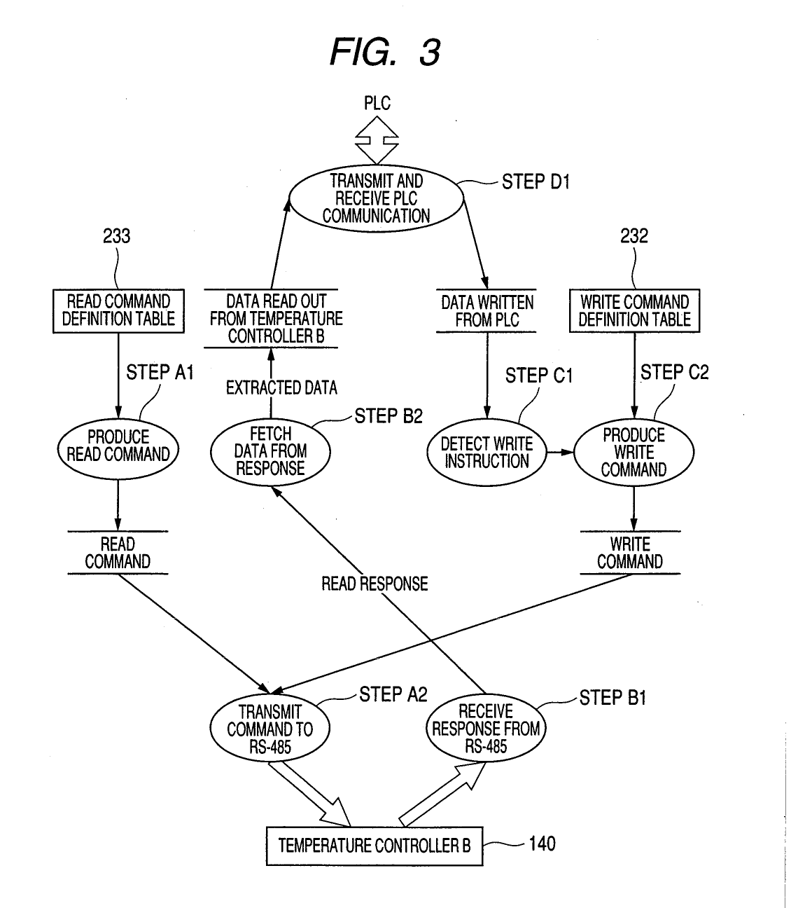

Next, the data flow in the temperature controller A 130 will be described with reference to FIG. 3. As a usual operation, first, an operation of transferring new data which are read out from the temperature controller B group and the temperature controller block 300, to the PLC 20 through the dedicated cable L3 by using a read command is repeated. By contrast, an operation of writing data into the temperature controller B group is performed only when necessary.

Hereinafter, the operations will be described specifically. When the power is turned on, the communication and conversion CPU 230 refers to a read command definition table 233 to produce a read command set (step A1).

The RS-485 circuit 260 transmits a read command to the temperature controller B group in accordance with instructions from the communication and conversion CPU 230 (step A2), and also outputs a read command to the temperature controller block 300 through the UART 240.

A response output from the temperature controller B 140 is first received by the RS-485 circuit 260 (step B1). The communication and conversion CPU 230 fetches data from the received response (step B2). The fetched data are stored in a buffer or like storage portion which is incorporated in the RS-485 circuit 260. As a usual operation, these operations are repeated.

In the temperature controller A 130, by contrast, when a write instruction is given from the PLC 20 to the data portion 231, the write instruction is detected in step Cl, a write command is produced in step C2 while referring to a write command definition table 232, and the RS-485 circuit 260 outputs the write command in accordance with instructions from the communication and conversion CPU 230 (step A2).

This operation is passively performed only when a write instruction is issued from the PLC 20 to the data portion 231 as described above.

In step D1, the transmitting and receiving functions of the PLC communication passively operate in accordance with instructions from the PLC 20. Namely, when the read instruction is given from the PLC 20, data which are read out from the temperature controllers A 130, B140 are returned to the PLC 20, and, when the write instruction is given, the contents of the data portion 231 are updated.

As described above, the temperature controller A 130 obtains data from the temperature controller B 140. Therefore, the plural temperature controllers can be handled as one controller, and hence the burden of the configuration work can be reduced. With respect to the wiring, a dedicated cable is connected only to the temperature controller A 130, and the other temperature controllers use only an RS-485 line which is economical, and which performs the serial communication. Therefore, the production cost can be reduced.

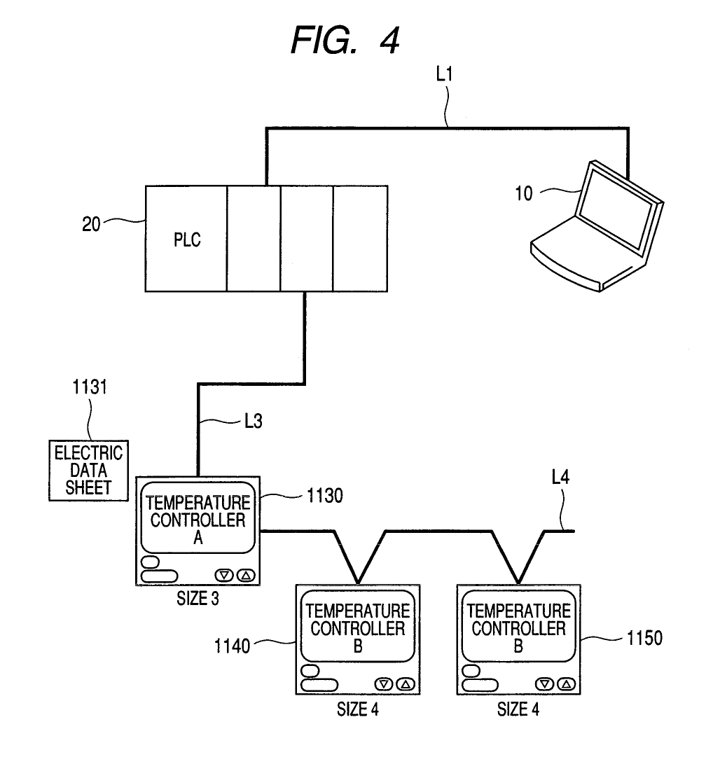

Next, a manner of using a temperature controller system of a second embodiment of the invention will be described with reference to FIG. 4. FIG. 4 is a diagram showing the concept of the whole temperature controller system of the invention. In the figure, the PC 10, the PLC 20, and the communication line L1 are identical with those shown in FIG. 8, and hence their detailed description is omitted.

Referring to the figure, a temperature controller A 1130 has a usual temperature adjusting function, and also has the PLC communicating function and a communication protocol converting function. The temperature controller A 1130 is connected to the PLC 20 through the dedicated cable L3 for the PLC communication, and includes a function of the serial multidrop communication (RS-485) to function as a master of communication, so that the temperature controller obtains data from the temperature controllers B 1140, 1150 which are slaves.

Furthermore, the temperature controller A 1130 is characterized in that EDS files corresponding to the temperature controllers B 1140, 1150 are produced for communication.

Also the temperature controllers B 1140, 1150 which function as slaves of the temperature controller A 1130 have a function of the serial multidrop communication (RS-485), and respectively include basic and standard data group lists (including “standard set list” which will be described later) which is used in the PLC communication.

The contents of the data group lists are determined on the basis of the type of the temperature controllers B 1140, 1150 and the method of using them. The lists contain also parameters which are frequently read and written during operation, such as a measure value (PV), and a set value (SP).

The standard set list is a part of the above-described data group list. In the standard set list, various parameters such as specific control and operation parameters which are set in the respective temperature controllers B 1140, 1150 are set in a list form. The standard set list is set by the manufacturer of a temperature controller.

The temperature controller A 1130 reads out the standard set lists which are set in all of the connected temperature controllers B 1140, 1150 through the above-described RS-485 communication cable L4. The temperature controller A 1130 refers to the standard set lists which are read out from the temperature controllers B 1140, 1150 and the set list which is possessed by the controller A 1130 itself, internally configures a memory map which is to be used in the PLC communication, produces only one EDS file 1131 which overall controls the temperature controllers B 1140, 1150, and records the EDS file 1131 in the controller A 1130.

The recorded EDS file 1131 is recorded and stored on a recording medium such as a CD-R by the temperature controller A 1130. The recording medium is caused by the user to be read by the PC 10, and the EDS file 1131 is registered into the PC 10.

By an operation of the user, then, the EDS file 1131 which overall controls the temperature controllers B 1140, 1150 is set into the PLC 20 through the communication line L1 by means of the PLC communication or dedicated communication. Therefore, communication with the temperature controller A 1130 and the temperature controllers B 1140, 1150 can be performed from the PLC 20.

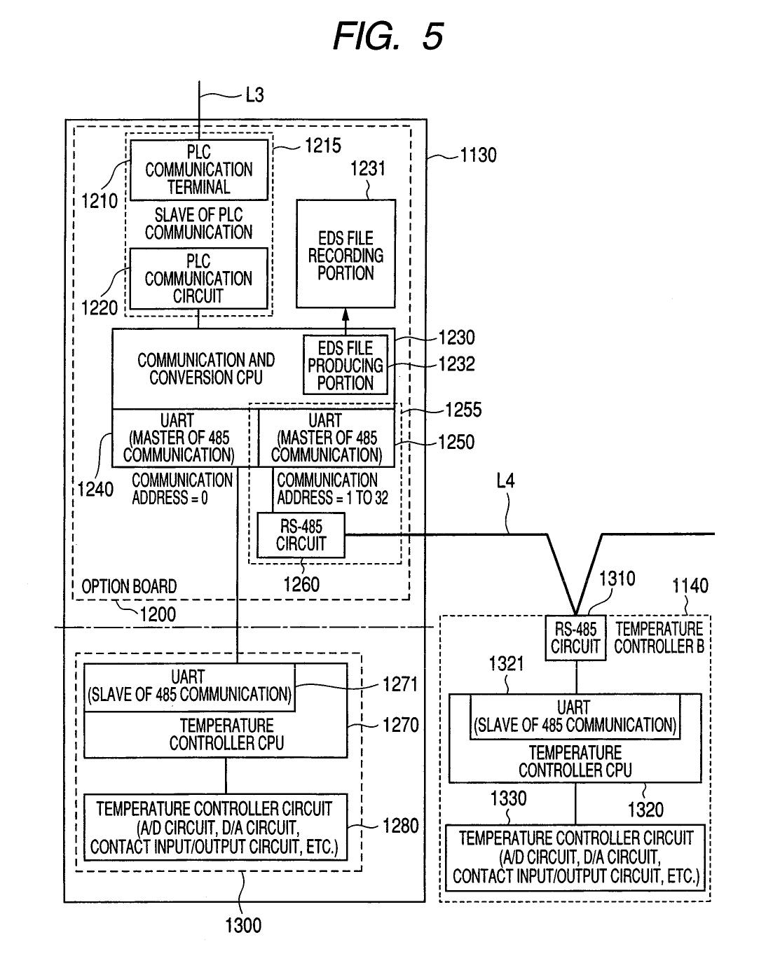

Next, the configuration and operation of the temperature controller A 1130 will be described in detail with reference to FIG. 5.

FIG. 5 is a diagram of the temperature controller A 1130 in the invention. The temperature controller A 1130 can be roughly divided into: an option board 1200 having the PLC communicating function, and a function of collecting information of the temperature controllers B 1140, 1150; and a temperature controller block 1300 having a function of a usual temperature controller.

The configuration of the option board 1200 will be described. A PLC communication terminal 1210 is connected to a dedicated cable L3 for the PLC communication. A PLC communication circuit 1220 communicates with the PLC 20 shown in FIG. 4 through the PLC communication terminal 1210. The PLC communication terminal 1210 and the PLC communication circuit 1220 constitute a PLC communicating portion 1215 which functions as a slave of the PLC communication while the PLC 20 functions as a master.

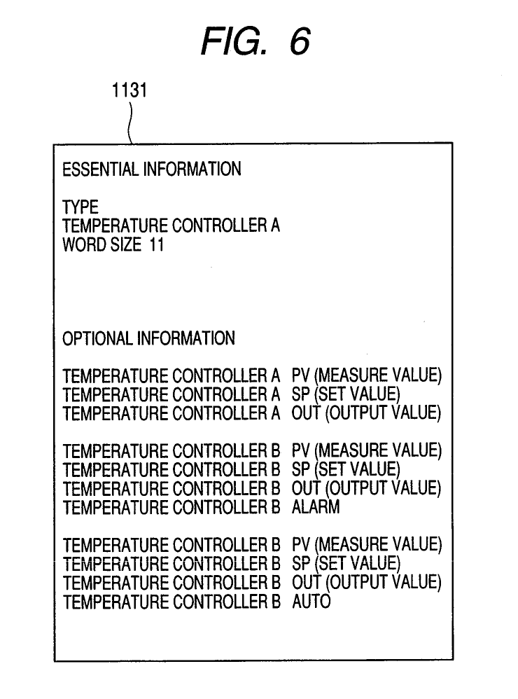

A communication and conversion CPU 1230 controls the PLC communication circuit 1220 to perform the PLC communication with the PLC 20 shown in FIG. 4, and produces an EDS file by using the function of an EDS file producing portion 1232. An EDS file recording portion 1231 records an EDS file which is produced by the communication and conversion CPU 1230 as described above. The EDS file producing portion 1232 produces an EDS file such as shown in FIG. 6 from the standard set list on the basis of the control of the communication and conversion CPU 1230.

The EDS file 1131 shown in FIG. 6 will be described. Unlike the related art, the single EDS file 1131 stores information of the all temperature controllers.

For example, it is assumed that the word size of the temperature controller A 1130 of FIG. 4 is “3”, that of the temperature controller B 1140 is “4”, and that of the temperature controller B 1150 is “4”. The word size which is essential information is “3”+“4”+“4”=“11”. As optional information, information based on the standard set lists of the temperature controller A 1130 and the temperature controllers B 1140, 1150 is stored in a number which is equal to the number of the word sizes.

In the EDS file 1131, information of three words of the measure value PV, the set value SP, and the output OUT is stored with respect to the temperature controller A 1130, that of four words of the measure value PV, the set value SP, the output OUT, and an alarm is stored with respect to the temperature controller B 1140, and that of four words of the measure value PV, the set value SP, the output OUT, and auto AUTO is stored with respect to the temperature controller B 1150.

A communication control element UART (Universal Asynchronous Receiver-Transmitter) 1240 is a master of the RS-485 communication (serial multidrop communication). For example, the communication address is set to “0”.

Furthermore, a communication control element UART 1250 is disposed. The UART 1250 is a master of the RS-485 communication. For example, communication addresses of “1” to “32” are used. The UART 1250 converts data of peripheral devices (in this case, the temperature controllers B 1140, 1150 and the like) to those in a format which can be handled by another apparatus (the PLC 20).

A communication circuit (RS-485 circuit) 1260 is a circuit which communicates with the temperature controllers B 1140, 1150 through a communication cable (RS-485 cable) L4, and includes a buffer which temporarily stores the standard set lists that are read out from the temperature controllers B 1140, 1150. The UART 1250 and the RS-485 circuit 1260 constitute an RS-485 communicating portion 1255.

Next, the temperature controller block 1300 will be described. A temperature controller CPU 1270 controls a temperature controller circuit 1280 for controlling the temperature, and also controls the RS-485 communication through a UART 1271. The UART 1271 is a slave of the RS-485 communication, and operates under the control of the temperature controller CPU 1270. The temperature controller circuit 1280 has a function of a usual temperature controller, and is configured, for example, by an A/D converter circuit, a D/A converter circuit, a contact input/output circuit, etc.

Then, the configuration of the temperature controller B 1140 will be exemplarily described. An RS-485 circuit 1310 performs the RS-485 communication with respect to the RS-485 circuit 1260 on the side of the temperature controller A 1130, through the RS-485 cable L4.

A temperature controller CPU 1320 controls a temperature controller circuit 1330, and also controls the RS-485 communication through a UART 1321. The UART 1321 is a slave of the RS-485 communication, and operates under the control of the temperature controller CPU 1320. The temperature controller circuit 1330 has a function of a usual temperature controller, and is configured, for example, by an A/D converter circuit, a D/A converter circuit, a contact input/output circuit, etc.

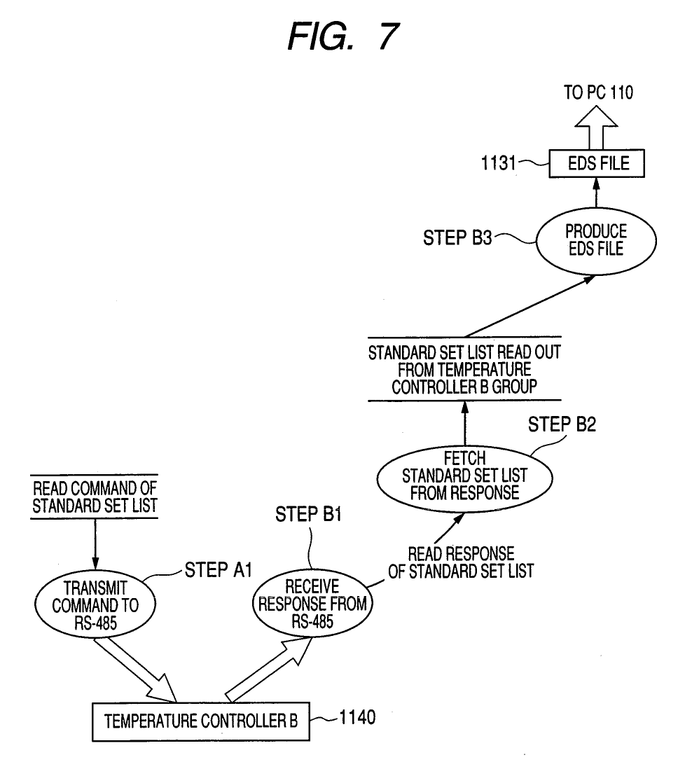

Next, a method of producing the EDS file 1131 corresponding to the temperature controller B 1140 by the temperature controller A 1130 will be described with reference to FIG. 7.

First, the communication and conversion CPU 1230 of the temperature controller A 1130 instructs the RS-485 communicating portion 1255 to output a standard set list read command to the temperature controller B 1140 (step A1).

The temperature controller B 1140 which receives the instruction outputs a response including a previously stored standard set list from the RS-485 circuit 1310 on the basis of instructions of the internal CPU 1320.

The response is received by the RS-485 circuit 1260 of the temperature controller A 1130 through the cable L4 (step B1). The communication and conversion CPU 1230 fetches data from the received response (step B2). The fetched data are temporarily stored in a buffer of the RS-485 circuit 1260 as the standard set list corresponding to the temperature controller B 1140.

From the standard set list stored in the buffer of the RS-485 circuit 1260, using the EDS file producing portion 1232, the communication and conversion CPU 1230 produces the EDS file 1131 which stores the memory map that is used in the PLC communication, as shown in FIG. 6, and records the file into the EDS file recording portion 1231 (step B3).

Also with respect to the temperature controller B 1150, by operations similar to those described above, the standard set list corresponding to the temperature controller B 1150 is read out, and reflected into the EDS file 1131.

The EDS file 1131 which is stored in the EDS file recording portion 1231 as described above may be recorded into an SD card which is not shown, and then transferred to the PC 10. In another method, an LL (Light Loader) communication cable is connected, and the file may be transferred to the PC 10 through the cable.

As described above, the EDS file 1131 is produced on the basis of the standard set lists read out from the respective temperature controllers. Therefore, the plural temperature controllers can be handled as one controller, and hence the burden of the configuration work can be reduced.

Even when the user is not familiar with the parameters of the temperature controllers, the temperature controller A 1130 reads out the recommended data group of the temperature controllers B 1140, 1150, and then produces an EDS file. Therefore, one EDS file can be sufficiently used, and the handling is facilitated.

Although the invention has been described in detail with reference to specific embodiments, it is obvious to those skilled in the art that various changes and modifications are possible without departing the spirit and scope of the invention.

What is claimed is:

1. A temperature controller system comprising:
a plurality of temperature controllers that adjust a temperature of a control object; and
a programmable logic controller to which the plurality of temperature controllers are connected,
wherein one of said temperature controllers includes
a PLC communicating portion which exchanges data with said programmable logic controller by a PLC communication,
a serial communication portion which exchanges data with another one of said temperature controllers that is connected in a downstream side, by a serial communication, and
a communication and conversion CPU which controls the data exchange performed between the PLC communicating portion and said programmable logic controller, and which controls serial communication performed by the serial communication portion.

2. A temperature controller system according to claim 1, wherein said one of temperature controllers is connected to said another one of temperature controllers that is in the downstream side, through a serial communication cable, and
wherein the serial communication portion includes
a communication control element which is a master of the serial communication performed with respect to said another one of temperature controllers that is connected in the downstream side, and
an RS-485 circuit which exchanges data with said another one of temperature controllers that is connected in the downstream side, through the serial communication cable.

3. A temperature controller system according to claim 1, wherein said one of temperature controllers is connected to said programmable logic controller through a dedicated cable, and
wherein the PLC communicating portion includes
a PLC communication terminal to which the dedicated cable is connected, and
a PLC communication circuit which exchanges data with said programmable logic controller through the PLC communication terminal.

4. A temperature controller system according to claim 2, wherein said another one of temperature controllers that is connected in the downstream side includes an RS-485 circuit which is connected to the serial communication cable.

5. A temperature controller system comprising:
a plurality of temperature controllers; and
a programmable logic controller to which the plurality of temperature controllers are connected,
wherein one of said temperature controllers which is used as a master includes
a file producing portion which, based on a standard set list that is obtained by means of communication from another one of said temperature controllers which is used as a slave, produces an electronic file storing information of said slave temperature controller, and
a file recording portion which records the electronic file.

6. A temperature controller system according to claim 5, wherein said master temperature controller and said slave temperature controller communicate with each other by means of serial multidrop communication.

7. A temperature controller system according to claim 6, wherein the serial multidrop communication is RS-485 communication.

8. A temperature controller system according to claim 5, wherein said programmable logic controller and said master temperature controller are connected to each other by means of PLC communication, and the electronic file is an EDS file.

9. A temperature controller system according to claim 5, wherein the electronic file is transmitted to a personal computer by means of LL communication.
